(19) United States
(12) Patent Application Publication
(10) Pub. No.: US 2007/0123426 A1
(43) Pub. Date: May 31, 2007

(54) Mixtures

(75) Inventors: Herve R. Vantieghem, Stutensee (DE); Bernd Sievernich, Hassloch (DE)

Correspondence Address: ROTHWELL, FIGG, ERNST & MANBECK, P.C., 1425 K STREET, N.W., SUITE 800, WASHINGTON, DC, 20005, US

(73) Assignee: BASF Aktiengesellschaft, Ludwigshafen (DE)

(21) Appl. No.: 11/588,425

(22) Filed: Oct. 27, 2006

(30) Foreign Application Priority Data
Nov. 25, 2005 (DE) 102005056590.5

(51) Int. Cl. A01N 43/80; A01N 25/02

(52) U.S. Cl. 504/271; 504/362

(57) ABSTRACT

Mixtures, comprising
a) a 4,5-dihydroisoxazol-3-yl-substituted benzoyl derivative of the formula I, 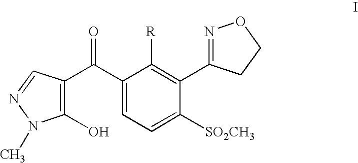 where R is chlorine or methyl, or one of its environmentally compatible salts, esters or amides; and
b) esters of C₆-C₂₂-fatty acids of vegetable origin.

The present invention relates to mixtures comprising
a) a 4,5-dihydroisoxazol-3-yl-substituted benzoyl derivative of the formula I, 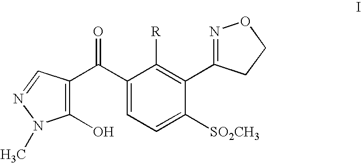
   where R is chlorine or methyl, or one of its environmentally compatible salts, esters or amides; and
b) esters of C₆-C₂₂-fatty acids of vegetable origin.

The present invention also relates to herbicidally active mixtures. In addition to components a) and b), the mixture may comprise other components. Examples of these are c) nitrogenous fertilizers, d) other herbicides or e) safeners.

Also part of the subject matter of the invention are compositions, such as, for example, the ready-to-use spray liquor, comprising the mixtures and also at least one liquid or solid carrier and if appropriate at least one surfactant.

Processes for preparing these compositions and their use and also methods for controlling unwanted vegetation are likewise part of the subject matter of the present invention.

Further embodiments of the present invention are evident from the claims, the description and the examples. It is to be understood that the features, both those mentioned above and those still to be illustrated below, of the subject matter of the invention can be used not only in the particular combination given but also in other combinations, without departing from the scope of the invention.

Compounds of the formula I belong to the compound class of the 3-heterocyclyl-substituted benzoyl derivatives, which class is known per se. Methods for preparing them are described, for example, in WO 98/31681.

3-Heterocyclyl-substituted benzoyl derivatives are suitable as herbicides. It is also known that they can be used in herbicidal mixtures.

Thus, WO 99/63823 discloses herbicidal mixtures of 3-heterocyclyl-substituted benzoyl derivatives, nitrogen fertilizers and an adjuvant.

WO 00/53014 discloses a synergistic mixture of 3-heterocyclyl-substituted benzoyl derivatives and an adjuvant comprising a C₁-C₅-alkyl C₅-C₂₂-alkanoate, a C₁₀-C₂₀-carboxylic acid, a partial phosphoric ester or a partial sulfuric ester of a monohydroxyfunctional polyalkyl ether and if appropriate an alkylpolyoxyalkylene polyether.

For crop protection agents, it is always desirable to increase the specific activity of the active compound and, at the same time, to ensure reliable application—even under suboptimal environmental conditions such as drought or rain.

It was an object of the present invention to develop mixtures based on 4,5-dihydroisoxazol-3-yl-substituted benzoyl derivatives with broad applicability. In particular, it was an object of the present invention to develop a herbicidally active mixture based on this class of active compounds which supports the specific activity of the active compound used and, at the same time, ensures reliable application.

A further aim was to reduce the amount of active compound applied and to find a herbicidally active mixture therefor. This should permit an ecological and economical approach and simultaneously an effective control of weeds.

This object was achieved using the mixtures described at the outset or herbicidally active compositions.

Component a) of the mixtures according to the invention is 4-[2-methyl-3-(4,5-dihydroisoxazol-3-yl)4-methylsulfonylbenzoyl]-1 -methyl-5-hydroxy-1H-pyrazole or 4-[2-chloro-3-(4,5-dihydroisoxazol-3-yl)-4-methylsulfonylbenzoyl]-1-methyl-5-hydroxy-1H-pyrazole, preferably 4-[2-methyl-3-(4,5-dihydroisoxazol-3-yl)4-methylsulfonylbenzoyl]-1-methyl-5-hydroxy-1H-pyrazole.

The esters, used as component b), of C₆-C₂₂-fatty acids of vegetable origin are known per se to the person skilled in the art as “methylated seed oil” or MSO. To prepare them, native vegetable oil, for example, is cleaved into glycerol and fatty acids; and the fatty acids are separated off and esterified, for example methylated or ethylated.

Plants or seeds thereof suitable for obtaining the native oil are, for example, soybeans, corn, sunflowers, oilseed rape, cotton, linseed, coconut, palm tree, thistle, walnut, peanut, olive or castor bean, in particular oilseed rape.

Depending on the oil variety, the fatty acids have from 6 to 22 carbon atoms, the main fraction being from C₁₄ to C₁₈. The fatty acids can be saturated or unsaturated.

Usually, the MSOs comprise methyl caproate, methyl caprylate, methyl caprate, methyl laurate, methyl myrisate, methyl stearate, methyl palmitate, methyl oleate, methyl linoleate, methyl linolenate or the ethyl esters in various distribution patterns, depending on the oil variety and the treatment. It is also possible to mix MSOs of different origin.

MSO is commercially available. Examples are DESTINY from Cenex, MSO Concentrate Oil from Loveland, “MSO” from Helena Chemical and SCOIL from Agsco.

In addition to MSO, commercial products may contain either UAN (urea ammonium nitrate) or AMS (ammonium sulfate), such as PERSIST PLUS and PERSIST EXTRA from Prescision (MSO plus UAN) and DYNE-A-PAK from Helena Chemical (MSO plus UAN). The user, for example the farmer, applies the herbicidal mixture according to the invention or the herbicidal composition usually from a predosage device, a knapsack sprayer, a spray tank or a spray plane. Here, the herbicidal mixture is made up with water and/or buffer to the desired application concentration, it being possible, if appropriate, to add further auxiliaries and additives, and the ready-to-use spray liquor or the herbicidal composition according to the invention is thus obtained. Usually, 50 to 500 liters of the ready-to-use spray liquor are applied per hectare of agricultural useful area, preferably 100 to 400 liters.

The mixture according to the invention is in particular herbicidally effective and comprises the components a) and b) in synergistically effective amounts. Its action is selective for those crop plants which are also compatible with the individual components.

The application rate of component a) in the mixture according to the invention is usually from 2.5 to 100 g/hectare, preferably from 5 to 75 g/hectare. Especially preferred are application rates from 5 to 25 g/hectare. This corresponds to a customary spray liquor volume of from 100 to 400 liters per hectare in a concentration range of component a) of from 0.00625 g/l_{spray liquor} to 1 g/l_{spray liquor}.

In one embodiment, mixtures comprising from 2.5 g to 100 g of component a) in 100 to 400 liters of spray liquor for an area of one hectare are used for pre-plant burn down—the destruction of unwanted vegetation prior to sowing of the crop plants; another embodiment for post-emergence application comprises from 5 to 75 g, preferably from 5 to 25 g, of component a) in 100 to 400 liters of spray liquor for an area of one hectare.

The mixture according to the invention or the herbicidal composition comprises component b), esters of C₆-C₂₂-fatty acids of vegetable origin, usually in an amount such that the spray liquor prepared by the user, for example the farmer, has a final concentration of from 0.5 to 2.5% by volume of MSO.

Preferably, the ready-to-use spray liquor comprises a final concentration of from 1.0 to 1.5% by volume of MSO, particularly preferably 1.25% by volume of MSO.

The specification % by volume relates to the overall volume of the herbicidal composition, for example of the ready-to-use spray liquor.

In a particularly preferred embodiment, the ready-to-use spray liquor comprises, at a customary spray liquor volume of 100 to 400 liters per hectare, from 1.0 to 1.5% by volume of component b) and component a) in such an amount that from 2.5 to 100 g of the active compound are applied per hectare.

Accordingly, the mixtures according to the invention or the ready-to-use spray liquor comprise the components a) and b) usually in a ratio (w/w) of from 1:2.5 to 1:5000 in a spray liquor volume of from 50 to 500 liters per hectare.

A mixing ratio (w/w) of components a) and b) of from 1:5 to 1:1000 is preferred. In a particularly preferred embodiment, the components a) and b) are present in the ready-to-use spray liquor in a ratio (w/w) of from 1:10 to 1:500.

The mixtures according to the invention can comprise the components a) and b) alone. However, they can also comprise one or more further components.

For example, a fertilizer c), in particular a nitrogenous fertilizer, may be added to the mixture according to the invention.

Suitable nitrogenous fertilizers are aqueous ammonia solutions, ammonium salts, urea, thiourea and mixtures thereof.

Ammonium salts are, for example, organic or inorganic salts, such as ammonium nitrate, ammonium sulfate, ammonium hydrogensulfate, ammonium chloride, ammonium acetate, ammonium formate, ammonium oxalate, ammonium carbonate, ammonium bicarbonate, ammonium thiosulfate, ammonium phosphate, ammonium hydrogendiphosphate, ammonium dihydrogenmonophosphate, ammonium sodium hydrogenphosphate, ammonium thiocyanate.

Suitable fertilizers are, inter alia, urea/ammonium nitrate (UAN).

In a particular embodiment, the nitrogenous fertilizer used is urea, ammonium nitrate, ammonium nitrate/urea, ammonium sulfate, ammonium phosphate, ammonium hydrogendiphosphate, ammonium dihydrogenmonophosphate or ammonium sodium hydrogenphosphate.

Very particular preference is given to urea, ammonium nitrate and ammonium nitrate/urea. Ammonium nitrate/urea is commercially available, for example as a solution having a total nitrogen content of 28-33% (w/w) as Ensol® 28 from BASF.

According to one embodiment, the mixture according to the invention or the herbicidal composition comprises nitrogenous fertilizer (component c)) in an amount such that the spray liquor prepared by the user, for example the farmer, has a final concentration of from 0.5 to 5% by weight, for example of ammonium nitrate/urea.

For example, 2.5 1 of a 20 to 60% by weight strength ammonium nitrate/urea-comprising solution may be added into a metering device to prepare 100 I of the ready-to-use spray liquor.

Preferably, the ready-to-use spray liquor comprises the fertilizer in a final concentration of from 1.5 to 3.0% by weight, particularly preferably 2.5% by weight.

In a particularly preferred embodiment, the ready-to-use spray liquor comprises, in a usual spray liquor volume of from 50 to 500 liters per hectare, from 0.5 to 5% by weight of the component c), and the component a) in an amount such that 2.5 to 100 g of the active compound are applied per hectare.

Accordingly, the mixtures according to the invention or the ready-to-use spray liquor comprise the components a) and c) usually in a ratio (w/w) of from 1:2.5 to 1:10 000.

A mixing ratio (w/w) of components a) and c) of from 1:20 to 1:2400 is preferred.

In a particularly preferred embodiment, the components a) and c) are present in the ready-to-use spray liquor in a ratio (w/w) of from 1:33 to 1:2000.

Furthermore, the mixture according to the invention may comprise one or more herbicides (component d)), for example from the group of the D1: acetyl-CoA carboxylase inhibitors (ACC), D2: acetolactate synthase inhibitors (ALS), D3: amides, D4: auxin herbicides, D5: auxin transport inhibitors, D6: carotinoid biosynthesis inhibitors, D7: enolpyruvylshikimate-3-phosphate synthase inhibitors (EPSPS), D8: glutamine synthetase inhibitors, D9: lipid biosynthesis inhibitors, D10: mitose inhibitors, Dl1: protoporphyrinogen IX oxidase inhibitors, D12: photosynthesis inhibitors, D13: synergists, D14: growth substances, D15: cell wall biosynthesis inhibitors, and also D16: various other herbicides.

The component d) used can be from the group of the acetyl-CoA carboxylase inhibitors (D1, ACC), for example cyclohexenone oxime ethers, phenoxyphenoxypropionic esters or arylaminopropionic acids. The acetolactate synthase inhibitors (D2, ALS) include, for example, imidazolinones, pyrimidyl ethers, triazolopyrimidines or sulfonylureas. Relevant auxin herbicides (D4) are, inter alia, pyridinecarboxylic acids, 2,4-D or benazolin. Lipid biosynthesis inhibitors (D9) used are, inter alia, anilides, chloroacetanilides, thioureas, benfuresate or perfluidone. Suitable mitosis inhibitors (D10) are, inter alia, carbamates, dinitroanilines, pyridines, butamifos, chlorthal-dimethyl (DCPA) or maleic hydrazide. Examples of protoporphyrinogen IX oxidase inhibitors (D11) are, inter alia, diphenyl ethers, oxadiazoles, cyclic imides or pyrazoles. Suitable photosynthesis inhibitors (D12) are, inter alia, propanil, pyridate, pyridafol, benzothiadiazinones, dinitrophenols, dipyridylenes, ureas, phenols, chloridazone, triazine, triazinone, uracils or biscarbamates. The synergists (D13) include, inter alia, oxiranes. Growth substances (D14) are, for example, aryloxyalkanoic acids, benzoic acids or quinolinecarboxylic acids. The group “various other herbicides” (D16) is to be understood as including, inter alia, the active compound classes of the dichloropropionic acids, dihydrobenzofurans, phenylacetic acids and also individual herbicides, as listed below, whose mechanism of action is not (fully) known.

Herbicides d) which can be used in combination with a compound of the formula I (component a)) and MSO (component b)) in accordance with the present invention are, for example:

D1 acetyl-CoA carboxylase inhibitors (ACC), for example
cyclohexenone oxime ethers, such as alloxydim, clethodim, cloproxydim, cycloxydim, sethoxydim, tralkoxydim, butroxydim, clefoxydim (=profoxydim) or tepraloxydim;
phenoxyphenoxypropionic esters, such as clodinafop-propargyl, cyhalofop-butyl, diclofop-methyl, fenoxaprop-ethyl, fenoxaprop-P-ethyl, fenthiaprop-ethyl, fluazifop-butyl, fluazifop-P-butyl, haloxyfop-ethoxyethyl, haloxyfop-methyl, haloxyfop-P-methyl, isoxapyrifop, metamifop, propaquizafop, quizalofop-ethyl, quizalofop-P-ethyl or quizalofop-tefuryl;
arylaminopropionic acids, such as flamprop-methyl or flamprop-isopropyl; or
ketoenols, such as pinoxaden;

D2 acetolactate synthase inhibitors (ALS), for example
imidazolinones, such as imazapyr, imazaquin, imazamethabenz-methyl (imazam), imazamox, imazapic, imazethapyr or imazamethapyr;
pyrimidyl ethers, such as pyrithiobac-acid, pyrithiobac-sodium, Bispyribac-sodium, KIH-6127 (pyriminobac-methyl), pyriftalid or pyribenzoxym;
triazolopyrimidines, such as florasulam, flumetsulam, metosulam, penoxsulam, diclosulam or cloransulam-methyl;
sulfonylureas, such as amidosulfuron, azimsulfuron, bensulfuron-methyl, chlorimuron-ethyl, chlorsulfuron, chinosulfuron, cyclosulfamuron, ethametsulfuron-methyl, ethoxysulfuron, flazasulfuron, flucetosulfuron, flupyrsulfuron-methyl-Na, foramsulfuron, halosulfuron-methyl, imazosulfuron, mesosulfuron, metsulfuron-methyl, nicosulfuron, orthosulfamuron, oxasulfuron, primisulfuron-methyl, prosulfuron, pyrazosulfuron-ethyl, rimsulfuron, sulfometuron-methyl, thifensulfuron-methyl, tria-sulfuron, tribenuron-methyl, triflusulfuron-methyl, trifloxysulfuron, tritosulfuron, sulfosulfuron or iodosulfuron;
sulfonylaminocarbonyltriazolinones, such as thiencarbazone, flucarbazone or propoxycarbazone-Na; or
sulfonanilides, such as pyrimisulfan;

D3 amides, for example
allidochlor (CDAA), benzoylprop-ethyl, bromobutide, chlorthiamid, diphenamid, etobenzanid (benzchlomet), fluthiamid, fosamin or monalide;

D4 auxin herbicides, for example
pyridinecarboxylic acids, such as aminopyralid, fluroxypyr, triclopyr, clopyralid or picloram; or
2,4-D or benazolin;

D5 auxin transport inhibitors, for example
naptalam or diflufenzopyr;

D6 carotinoid biosynthesis inhibitors, for example
beflubutamid, benzofenap, clomazone (dimethazone), diflufenican, fluorochloridone, fluridone, pyrasulfutole, pyrazolynate, pyrazoxyfen, isoxaflutole, isoxachlortole, mesotrione, sulcotrione (chlormesulone), tembotrione, ketospiradox, flurtamone, norflurazon, amitrole, picolinafen, benzobicyclon, tefuryltrione or CAS No.:352010-68-5;

D7 enolpyruvylshikimate-3-phosphate synthase inhibitors (EPSPS), for example
glyphosate or sulfosate;

D8 glutamine synthetase inhibitors, for example
bilanafos (bialaphos) or glufosinate-ammonium,

D9 lipid biosynthesis inhibitors, for example
anilides, such as anilofos or mefenacet;
chioroacetanilides, such as dimethenamid, S-dimethenamid, acetochlor, alachlor, butachlor, butenachlor, diethatyl-ethyl, dimethachlor, metazachlor, metolachlor, S-metolachlor, pethoxamid, pretilachlor, propachlor, prynachlor, terbuchlor, thenylchlor or xylachlor;
acetamides, such as diphenamid, napropamid and naproanilide;
oxyacetamides, such as flufenacet;
thioureas, such as butylate, cycloate, diallate, dimepiperate, EPTC, esprocarb, molinate, pebulate, prosulfocarb, thiobencarb (benthiocarb), triallate or vernolate; or
tetrazolinones, such as fentrazamide;
isoxazolines, such as pyroxasulfon (KIH-485);
benfuresate, ethofumesate, cafenstrole or perfluidone;

D10 mitosis inhibitors, for example
carbamates, such as asulam, carbetamid, chlorpropham, orbencarb, pronamid (propyzamid), propham or thiocarbazil;
dinitroanilines, such as benefin (=benfluralin), butralin, dinitramin, ethalfluralin, fluchloralin, oryzalin, pendimethalin, prodiamine or trifluralin;
pyridines, such as dithiopyr or thiazopyr; or
butamifos, chlorthal-dimethyl (DCPA) or maleic hydrazide;

D11 protoporphyrinogen IX oxidase inhibitors, for example
diphenyl ethers, such as acifluorfen, acifluorfen-sodium, aclonifen, bifenox, chlomitrofen (CNP), ethoxyfen, fluorodifen, fluoroglycofen-ethyl, fomesafen, furyloxyfen, lactofen, nitrofen, nitrofluorfen or oxyfluorfen;
oxadiazoles, such as oxadiargyl or oxadiazon;
cyclic imides, such as azafenidin, butafenacil, carfentrazone-ethyl, cinidon-ethyl, flumiclorac-pentyl, flumioxazin, flumipropyn, flupropacil, fluthiacet-methyl, sulfentrazone or thidiazimin;
pyrazoles, such as pyraflufen-ethyl (ET-751), fluazolat (JV 485) or nipyraclofen;
pyridazinones, such as flufenpyr-ethyl; or
triazolones, such as bencarbazone;

D12 photosynthesis inhibitors, for example
propanil, pyridate or pyridafol;
benzothiadiazinones, such as bentazone;
dinitrophenols, such as bromofenoxim, dinoseb, dinoseb-acetate, dinoterb or DNOC;
dipyridyienes, such as cyperquat-chloride, difenzoquat-methylsulfate, diquat or paraquat-dichloride;
ureas, such as chlorbromuron, chlortoluron, difenoxuron, dimefuron, diuron, ethidimuron, fenuron, fluometuron, isoproturon, isouron, linuron, methabenzthiazuron, methazole, metobenzuron, metoxuron, monolinuron, neburon, siduron or tebuthiuron;
phenols, such as bromoxynil or ioxynil;
chloridazon;
triazines, such as ametryn, atrazine, cyanazine, desmetryn, dimethamethryn, hexazinone, prometon, prometryn, propazine, simazine, simetryn, terbumeton, terbutryn, terbuthylazine or trietazine;
triazinones, such as metamitron or metribuzin;
uracils, such as bromacil, lenacil or terbacil; or
biscarbamates, such as desmedipham or phenmedipham;
triazolinones, such as amicarbazone;

D13 synergists, for example
oxiranes, such as tridiphane;

D14 growth substances, for example
aryloxyalkanoic acids, such as, for example, 2,4-DB, clomeprop, dichlorprop, dichlorprop-P (2,4-DP-P), fluoroxypyr, MCPA, MCPB, mecoprop, mecoprop-P or triclopyr;
benzoic acids, such as chloramben or dicamba; or
quinolinecarboxylic acids, such as quinclorac or quinmerac;

D15 cell wall synthesis inhibitors, for example
isoxaben, flupoxam or dichlobenil;

D16 various other herbicides, for example
dichloropropionic acids, such as dalapon;
dihydrobenzofurans, such as ethofumesate;
phenylacetic acids, such as chlorfenac (fenac); or
aziprotryn, barban, bensulide, benzthiazuron, benzofluor, buminafos, buthidazole, buturon, cafenstrole, chlorbufam, chlorfenprop-methyl, chlorxuron, cinmethylin, cumyluron, cycluron, cyprazine, cyprazole, dibenzyluron, dipropetryn, dymron, eglinazine-ethyl, endothall, ethiozin, flucabazone, fluorbentranil, flupoxam, isocarbamid, isopropalin, karbutilate, mefluidid, monuron, napropamide, napropanilide, nitralin, oxaciclomefone, phenisopham, piperophos, procyazine, profluralin, pyributicarb, secbumeton, sulfallate (CDEC), terbucarb, triaziflam, triazofenamid or trimeturon.

Herbicides d) which are preferably used in combination with a compound of the formula I (component a)) and MSO (component b)) in accordance with the present invention are, for example:

D1 acetyl-CoA carboxylase inhibitors (ACC), for example
cyclohexenone oxime ethers, such as alloxydim, clethodim, cloproxydim, cycloxydim, sethoxydim, tralkoxydim, butroxydim, clefoxydim or tepraloxydim;
phenoxyphenoxypropionic esters, such as clodinafop-propargyl, cyhalofop-butyl, diclofop-methyl, fenoxaprop-ethyl, fenoxaprop-P-ethyl, fenthiaprop-ethyl, fluazifop-butyl, fluazifop-P-butyl, haloxyfop-ethoxyethyl, haloxyfop-methyl, haloxyfop-P-methyl, isoxapyrifop, metamifop, propaquizafop, quizalofop-ethyl, quizalofop-P-ethyl or quizalofop-tefuryl;
arylaminopropionic acids, such as flamprop-methyl or flamprop-isopropyl; or
ketoenols, such as pinoxaden;

D2 acetolactate synthase inhibitors (ALS), for example
imidazolinones, such as imazapyr, imazaquin, imazamethabenz-methyl (imazam), imazamox, imazapic, imazethapyr or imazamethapyr;
pyrimidyl ethers, such as pyrithiobac-acid, pyrithiobac-sodium, Bispyribac-sodium, KIH-6127 or pyribenzoxym;
triazolopyrimidines, such as florasulam, flumetsulam, metosulam or penoxsulam;
sulfonylureas, such as amidosulfuron, azimsulfuron, bensulfuron-methyl, chlorimuron-ethyl, chlorsulfuron, chinosulfuron, cyclosulfamuron, ethametsulfuron-methyl, ethoxysulfuron, flazasulfuron, flucetosulfuron, halosulfuron-methyl, imazo-sulfuron, metsulfuron-methyl, nicosulfuron, orthosulfamuron, primisulfuron-methyl, prosulfuron, pyrazosulfuron-ethyl, rimsulfuron, sulfometuron-methyl, thifensulfuron-methyl, triasulfuron, tribenuron-methyl, triflusulfuron-methyl, tritosulfuron, sulfosulfuron or iodosulfuron;
sulfonylaminocarbonyltriazolinones, such as thiencarbazone; or
sulfonanilides, such as pyrimisulfan;

D3 amides, for example
allidochlor (CDAA), benzoylprop-ethyl, bromobutide, chlorthiamid, diphenamid, etobenzanid (benzchlomet), fluthiamid, fosamin or monalide;

D4 auxin herbicides, for example
pyridinecarboxylic acids, such as aminopyralid, clopyralid or picloram; or
2,4-D or benazolin;

D5 auxin transport inhibitors, for example
naptalam or diflufenzopyr;

D6 carotinoid biosynthesis inhibitors, for example
beflubutamid, benzofenap, clomazone (dimethazone), diflufenican, fluorochloridone, fluridone, pyrasulfutole, pyrazolynate, pyrazoxyfen, isoxaflutole, isoxachlortole, mesotrione, sulcotrione (chlormesulone), tembotrione, ketospiradox, flurtamone, norflurazon, amitrole or CAS No.:352010-68-5;

D7 enolpyruvylshikimate-3-phosphate synthase inhibitors (EPSPS), for example
glyphosate or sulfosate;

D8 glutamine synthetase inhibitors, for example
bilanafos (bialaphos) or glufosinate-ammonium,

D9 lipid biosynthesis inhibitors, for example
anilides, such as anilofos or mefenacet;
chloroacetanilides, such as dimethenamid, S-dimethenamid, acetochlor, alachlor, butachlor, butenachlor, diethatyl-ethyl, dimethachlor, metazachlor, metolachlor, S-metolachlor, pethoxamid, pretilachlor, propachlor, prynachior, terbuchlor, thenylchlor or xylachlor;
thioureas, such as butylate, cycloate, diallate, dimepiperate, EPTC, esprocarb, molinate, pebulate, prosulfocarb, thiobencarb (benthiocarb), triallate or vemolate; or
benfuresate or perfluidone;

D10 mitosis inhibitors, for example
carbamates, such as asulam, carbetamid, chlorpropham, orbencarb, pronamid (propyzamid), propham or tiocarbazil;
dinitroanilines, such as benefin, butralin, dinitramin, ethalfluralin, fluchloralin, oryzalin, pendimethalin, prodiamine or trifluralin;
pyridines, such as dithiopyr or thiazopyr; or
butamifos, chlorthal-dimethyl (DCPA) or maleic hydrazide;

D11 protoporphyrinogen IX oxidase inhibitors, for example
diphenyl ethers, such as acifluorfen, acifluorfen-sodium, aclonifen, bifenox, chlomitrofen (CNP), ethoxyfen, fluorodifen, fluoroglycofen-ethyl, fomesafen, furyloxyfen, lactofen, nitrofen, nitrofluorfen or oxyfluorfen;
oxadiazoles, such as oxadiargyl or oxadiazon;
cyclic imides, such as azafenidin, butafenacil, carfentrazone-ethyl, cinidon-ethyl, flumiclorac-pentyl, flumioxazin, flumipropyn, flupropacil, fluthiacet-methyl, sulfentrazone or thidiazimin;
pyrazoles, such as ET-751, JV 485 or nipyraclofen;
pyridazinones, such as flufenpyr-ethyl; or
triazolones, such as bencarbazone;

D12 photosynthesis inhibitors, for example
propanil, pyridate or pyridafol;
benzothiadiazinones, such as bentazone;
dinitrophenols, such as bromofenoxim, dinoseb, dinoseb-acetate, dinoterb or DNOC;
dipyridylenes, such as cyperquat-chloride, difenzoquat-methylsulfate, diquat or paraquat-dichloride;
ureas, such as chlorbromuron, chlortoluron, difenoxuron, dimefuron, diuron, ethidimuron, fenuron, fluometuron, isoproturon, isouron, linuron, methabenzthiazuron, methazole, metobenzuron, metoxuron, monolinuron, neburon, siduron or tebuthiuron;
phenols, such as bromoxynil or ioxynil;
chioridazon;
triazines, such as ametryn, atrazine, cyanazine, desmetryn, dimethamethryn, hexazinone, prometon, prometryn, propazine, simazine, simetryn, terbumeton, terbutryn, terbuthylazine or trietazine;
triazinones, such as metamitron or metribuzin;
uracils, such as bromacil, lenacil or terbacil; or
biscarbamates, such as desmedipham or phenmedipham;

D13 synergists, for example
oxiranes, such as tridiphane;

D14 growth substances, for example
aryloxyalkanoic acids, such as, for example, 2,4-DB, clomeprop, dichlorprop, dichlorprop-P (2,4-DP-P), fluoroxypyr, MCPA, MCPB, mecoprop, mecoprop-P or triclopyr;
benzoic acids, such as chloramben or dicamba; or
quinolinecarboxylic acids, such as quinclorac or quinmerac;

D15 cell wall synthesis inhibitors, for example
isoxaben or dichlobenil;

D16 various other herbicides, for example
dichloropropionic acids, such as dalapon;
dihydrobenzofurans, such as ethofumesate;
phenylacetic acids, such as chlorfenac (fenac); or
aziprotryn, barban, bensulide, benzthiazuron, benzofluor, buminafos, buthidazole, buturon, cafenstrole, chlorbufam, chlorfenprop-methyl, chlorxuron, cinmethylin, cumyluron, cycluron, cyprazine, cyprazole, dibenzyluron, dipropetryn, dymron, eglinazine-ethyl, endothall, ethiozin, flucabazone, fluorbentranil, flupoxam, isocarbamid, isopropalin, karbutilate, mefluidid, monuron, napropamide, napropanilide, nitralin, oxaciclomefone, phenisopham, piperophos, procyazine, profluralin, pyributicarb, secbumeton, sulfallate (CDEC), terbucarb, triaziflam, triazofenamid or trimeturon.

The allocation of the active compounds to the particular mechanisms of action is based on current knowledge. If an active compound acts through a plurality of mechanisms of action, only one mechanism of action was allocated to the compound in question.

According to one embodiment, particular preference is given to components d) from the active compound classes mentioned below or the following compounds:

D2 acetolactate synthase inhibitors (ALS):
sulfonylureas, in particular nicosulfuron

D9 lipid biosynthesis inhibitors:
chloroacetanilides, in particular dimethenamid, S-dimethenamid, acetochlor, metolachlor, S-metolachlor;
thioureas, in particular benthiocarb;
isoxazolines, such as pyroxasulfon (KIH-485);

D12 photosynthesis inhibitors:
pyridate;
benzothiadiazinones, in particular bentazone;

dipyridylenes, in particular paraquat-dichloride;
ureas, in particular diuron or isoproturon, especially diuron;
phenols, in particular bromoxynil;
chloridazon;
triazines, in particular atrazine or terbutylazine; or
triazinones, in particular metribuzin;

According to another embodiment, particular preference is likewise given to components d) from the active compound classes mentioned below, or to the following compounds:

D2 acetolactate synthase inhibitors (ALS):
sulfonylureas, in particular nicosulfuron

D9 lipid biosynthesis inhibitors:
chloroacetanilides, in particular dimethenamid, S-dimethenamid, acetochlor, metolachlor or S-metolachlor,
thioureas, in particular benthiocarb;

D12 photosynthesis inhibitors:
pyridate;
benzothiadiazinones, in particular bentazone;
dipyridylenes, in particular paraquat-dichloride;
ureas, in particular diuron or isoproturon, in particular diuron;
phenols, in particular bromoxynil;
chloridazon;
triazines, in particular atrazine or terbutylazine; or
triazinones, in particular metribuzin.

According to another embodiment, particularly preferred components d) of the mixtures according to the invention are triazines, and from among these in particular atrazine or terbutylazine.

In a further embodiment, a preferred component d) of the mixtures according to the invention is the combination of triazines and chloroacetanilides, in particular of atrazine and dimethenamid or S-dimethenamid.

In a further embodiment, a preferred component d) of the mixtures according to the invention is the combination of triazines and chloroacetanilides, in particular of atrazine and metazachlor.

In a further embodiment, a preferred component d) of the mixtures according to the invention are chloroacetanilides, in particular metazachlor.

In a further embodiment, a preferred component d) of the mixtures according to the invention are quinolinecarboxylic acids, in particular quinmerac.

Also especially preferred as component d) of the mixtures according to the invention is the combination of triazines and sulfonylureas, in particular of atrazine and nicosulfuron.

The weight ratio of component a) and component d) in the herbicidal mixture or in the composition according to the invention is preferably in the range from 1:0.001 to 1:500, preferably from 1:0.01 to 1:200, particularly preferably from 1:0.01 to 1:100.

Furthermore, the mixture according to the invention may, as component e), comprise a safener.

Suitable safeners e) are substances such as benoxacor, cloquintocet, cyometrinil, dichlormid, dicyclonon, dietholate, fenchchlorazole, fenclorim, flurazole, fluxofenim, furilazole, isoxadifen, mefenpyr, mephenate, naphtalic anhydride, 2,2,5-trimethyl-3-(dichloroacetyl)-1,3-oxazolidine (R-29148), 4-(dichloroacetyl)-1-oxa4-azaspiro[4.5]decane (AD-67, MON 4660), N-[[4-[(cyclopropylamino)carbonyl]phenyl]sulfonyl]-2-methoxybenzamide II (CAS no. 221667-31-8, cyprosulfamid) and also oxabetrinil.

In one embodiment of the invention, the following safeners are particularly preferred: benoxacor, cloquintocet, dichlormid, fenchlorazole, fenclorim, fluxofenim, furilazole, isoxadifen, mefenpyr, AD-67 and oxabetrinil.

In another embodiment of the invention, the following safeners are particularly preferred: benoxacor, cloquintocet, dichlormid, fenchchlorazole, fenclorim, fluxofenim, furilazole, isoxadifen, mefenpyr and oxabetrinil.

Both component a) and also the herbicides d) from groups D1 to D16 and the components e) may also be present in the form of their environmentally compatible salts, esters and amides. Suitable salts are, in general, the salts of those cations or the acid addition salts of those acids whose cations and anions, respectively, have no negative effect on the herbicidal action of the active compounds.

Suitable cations are in particular ions of the alkali metals, preferably lithium, sodium and potassium, of the alkaline earth metals, preferably calcium and magnesium, and the transition metals, preferably manganese, copper, zinc and iron, and also ammonium, it being possible in this case, if desired, to replace one to four hydrogen atoms by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, isopropylammonium, dimethylammonium, diisopropylammonium, tetramethylammonium, tetrabutylammonium, 2-(2-hydroxyeth-1-oxy)eth-1-ylammonium, di(2-hydroxyeth-1 -yl)ammonium, trimethylbenzylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of suitable acid addition salts are primarily chloride, bromide, fluoride, hydrogensulfate, sulfate, dihydrogenphosphate, hydrogenphosphate, nitrate, bicarbonate, carbonate, hexafluorosilicate, hexafluorophosphate, benzoate and also the anions of the C₁-C₄-alkanoic acids, preferably formate, acetate, propionate and butyrate.

Suitable esters are alkyl, alkoxyalkyl, allyl, propargyl and oxetan-3-yl esters, preferably C₁-C₁₀ esters, for example methyl, ethyl, propyl, isopropyl, butyl, isobutyl, pentyl, mexyl (≡1-methylhexyl) or isoctyl-(-2-ethylhexyl) esters, C₁-C₄-alkoxyethyl esters, for example methoxyethyl, ethoxyethyl or butoxyethyl esters, allyl esters, propargyl esters and oxetan-3-yl esters.

Suitable amides are unsubstituted amides, alkyl- and dialkylamides and also anilides, preferably C₁-C₄-alkylamides, for example methyl- or ethylamides, di(C₁-C₄-alkyl)amides, for example dimethyl- or diethylamides, or anilides, preferably the unsubstituted anilide or 2-chloroanilide.

The components a), d) and e) and/or their salts, esters, amides and hydrates can be present in the mixture according to the invention as pure enantiomers, and also as racemates or diastereomer mixtures, or as tautomers.

The components a) to e) can be used individually or already partially or completely mixed with one another to prepare the herbicidal mixture according to the invention. It is also possible for them to be packaged and used further as combination composition such as a kit of parts.

In one embodiment of the invention, component a) can be used as pure active compound for preparing the herbicidal mixture. According to another embodiment of the invention, component a) is present, for example, as an active compound formulated with auxiliaries. In both forms, component a) may be applied separately from or together with the further components or as a component of a combination composition according to the invention for preparing the mixture according to the invention.

The further components of the mixture according to the invention can likewise be formulated using auxiliaries to prepare them.

The mixture according to the invention or the herbicidal composition according to the invention can beapplied, for example, in the form of directly sprayable aqueous solutions or dispersions including highly concentrated aqueous, oily or other suspensions or emulsions by spraying, atomizing or watering. The application forms depend on the intended purposes; in each case, they should ensure the finest possible distribution of the herbicidal mixture according to the invention.

Aqueous application forms of the mixture according to the invention can be produced from emulsion concentrates, suspensions, pastes, wettable powders or water-dispersible granules. To prepare emulsions, pastes or oil dispersions, the herbicidal mixture or components thereof, as such or dissolved in an oil or solvent, may be homogenized in water using wetting agents, adhesives, dispersants or emulsifiers. However, it is also possible to prepare, from the herbicidal mixture or components thereof, welting agent, adhesive, dispersant or emulsifier and optionally solvent or oil, concentrates suitable for dilution with water.

Powders, materials for spreading and dusts can be prepared, for example, by mixing or joint grinding of component a), if appropriate fertilizer c), if appropriate, further herbicides d) and, if appropriate, safeners e) with a solid carrier.

Granules, for example coated granules, impregnated granules and homogeneous granules, can be prepared by binding the component a), if appropriate fertilizers c), if appropriate, other herbicides d) and, if appropriate safeners e) to solid carriers.

The user, for example the farmer, applies the herbicidal mixture according to the invention, or the herbicidal composition, usually from a predosage device, a knapsack sprayer, a spray tank or a spray plane. According to one embodiment of the invention, the herbicidal mixture is made up with water and/or buffer to the desired application concentration, it being possible, if appropriate, to add further auxiliaries and additives.

According to another embodiment, the individual components of the herbicidal mixture according to the invention may be mixed by the user himself in a spray tank and further auxiliaries and additives may be added, if appropriate (tank mix method).

In a further embodiment, either individual components of the herbicidal mixture according to the invention or partially premixed components, for example a) and d) may be mixed by the user in a spray tank and further auxiliaries and additives may be added, if appropriate (tank mix method).

In a further embodiment, the components a) and/or, if appropriate, d) and/or, if appropriate, e) are added in formulated form to the dosage device and diluted to the desired application concentration.

According to another embodiment, the component b), MSO, is admixed in the tank.

Suitable auxiliaries and additives for the formulation of the individual components of the mixture according to the invention itself or for the preparation of the mixture according to the invention or of the composition, such as, for example, of the ready-to-use spray liquor are generally, for example:

Inert additives or carriers, such as mineral oil fractions of medium to high boiling point, such as kerosine or diesel oil, furthermore coal tar oils and also oils of vegetable or animal origin, aliphatic, cyclic and aromatic hydrocarbons, for example paraffin, tetrahydronaphthalene, alkylated naphthalenes or derivatives thereof, alkylated benzenes or derivatives thereof, alcohols, such as methanol, ethanol, propanol, butanol, cyclohexanol, ketones, such as cyclohexanone, or strongly polar solvents, for example amines, such as N-methylpyrrolidone, or water.

Suitable adjuvants for a formulation of component a) and/or, if appropriate, d) and/or, if appropriate, e) are vegetable oils which may be partially hydrogenated and hydrogenated, modified, for example esterified, vegetable oils, mineral oils, alcohol alkoxylates, alcohol ethoxylates, alkylated (ethylene oxide (EO)/propylene oxide (PO)) block copolymers, alkylphenol ethoxylates, polyols, EO/PO block copolymers, organosilicon compounds, alkyl glycosides, alkyl polyglycosides, alkyl sulfates, sulfated alcohol alkoxylates, alkylarylsulfonates, alkylsulfonates, dialkyl sulfosuccinates, phosphated alcohol alkoxylates, fatty amine alkoxylates, esters, carboxylates, ester ethoxylates, dialkyl adipates, dicarboxylic acid derivatives, such as condensates of succinic anhydride with allyl alcohol and polyalkylene oxide or polyhydroxyamines, dialkyl phthalates, ethoxylated sorbitan esters and ethoxylated glycerides of natural fatty acids.

Preferred adjuvants are alcohol alkoxylates, such as alkyl ether of (ethylene oxide (EO)/propylene oxide (PO)) copolymers, for example Plurafac® (BASF AG), Synperionic® LF (ICI), alcohol ethoxylates, where the alcohol is a C₈-C₁₈-alcohol of synthetic or natural origin which may be straight-chain or branched. The ethoxylate moiety comprises on average 3 to 20 mol of ethylene oxide, depending on the alcohol employed. Products which may be used are, for example, Lutensol® ON, TO, AO and A from BASF, alkylarylsulfonates, such as nonylphenol ethoxylates with 5-15 mol of EO, polyols, such as polyethylene glycol or polypropylene glycol, EO/PO block copolymers, such as, for example, Pluronic® PE (BASF) or Synperionic® PE (ICI), organosilicon compounds, alkyl polyglycosides, such as, for example, Agrimul® (Henkel KGA), AG 6202 (Akzo-Nobel), Atplus® 450 (ICI) or Lutensol® GD 70 (BASF), fatty amine alkoxylates, such as, for example, Ethomeen® and Armobleem® from Akzo Nobel, esters of natural and synthetic fatty acids, such as, for example, methyl oleate or methyl cocoate, dialkyl adipates, ethoxylated sorbitan esters of natural fatty acids, such as Tween® from ICI Surfactants (Tween® 20, Tween® 85, Tween® 80), ethoxylated glycerides of natural fatty acids, such as, for example, Glycerox® from Croda.

Further examples can be found in:

McCutcheon's; Emulsifiers and Detergents,

Volumes 1 and 2: Emulsifiers and Detergents 1994

North American Edition;

McCutcheon3 s Division, Glen Rock N.J., USA,

Surfactants in Europe;

A Directory of surface active agents available in Europe

2nd Ed. 1989;

Terg Data, Darlington, England,

Ash, Michael;

Handbook of cosmetic and personal care additives

1994;

Gower Publishing Ltd, Aldershot, England

Ash, Michael;

Handbook of industrial Surfactants

1993;

Gower Publishing Ltd. Aldershot, England.

Buffers or buffer solutions are solutions which, on addition of strong acids or bases, hardly change their pH. In most cases, buffer solutions consist of a weak acid, for example, acetic acid, and one of the salts thereof, for example sodium acetate.

It is possible to add further auxiliaries and additives for easier processing. The following components have been found to be suitable auxiliaries and additives: further solvents, defoamers, buffers, thickeners, spreading agents, compatibility-enhancing agents, liquid and solid carriers, surfactants.

Solid carriers are, for example, mineral earths, such as silicic acids, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers, such as ammonium sulfate, ammonium phosphate, ammonium nitrate, ureas and products of vegetable origin, such as cereal meal, tree bark meal, wood meal and nutshell meal, cellulose powder or other solid carriers.

Suitable surfactants are the alkali metal, alkaline earth metal and ammonium salts of aromatic sulfonic acids, for example lignin-, phenol-, naphthalene- and dibutyl-naphthalenesulfonic acid, and also of fatty acids, alkyl- and alkylarylsulfonates, alkyl sulfates, lauryl ether sulfates and fatty alcohol sulfates, and also salts of sulfated hexa-, hepta- and octadecanols and also of fatty alcohol glycol ethers, condensates of sulfonated naphthalene and its derivatives with formaldehyde, condensates of naphthalene or of naphthalenesulfonic acid with phenol and formaldehyde, polyoxyethylene octylphenol ether, ethoxylated isooctyl-, octyl- or nonylphenol, alkylphenyl polyglycol ethers, tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors or methyicellulose.

Examples of these are described in Farm Chemicals Handbook 1997; Meister Publishing 1997 p. CIO “adjuvant” or 1998 Weed Control Manual p. 86.

It may be beneficial to apply the herbicidal mixture alone or jointly in combination with other herbicides or else in the form of a mixture with further crop protection agents, for example with agents for controlling pests or phytopathogenic fungi or bacteria. Also of interest is the miscibility with mineral salt solutions, which are employed for treating nutritional and trace deficiencies.

The mixture according to the invention is suitable as a herbicide. The herbicidal mixture effects very good control of vegetation on non-crop areas.

In crops such as wheat, rice, corn, soybeans and cotton, it acts against broad-leaved weeds and weed grasses, without causing any significant damage to the crop plants. This effect is mainly observed at low application rates.

Depending on the application method in question, the herbicidal mixture can be used in a further number of crop plants for eliminating unwanted plants. Suitable are, for example, the following crops:

Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica nigra, Brassica oleracea, Brassica rapa var. silvestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, lpomoea batatas, Juglans regia, Lens culinaris, Linum usitatissimum, Lycopersicon lycopersicum, Malus spec., Manihot esculenta, Medicago sativa, Musa spec., Nicotiana tabacum (N.rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticale, Triticum aestivum, Triticum durum, Vicia faba, Vitis vinifera and Zea mays.

The following crops are preferred:

Allium cepa, Ananas comosus, Arachis hypogaea, Asparagus officinalis, Beta vulgaris spec. altissima, Beta vulgaris spec. rapa, Brassica napus var. napus, Brassica napus var. napobrassica, Brassica rapa var. silvestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus anhuus, Hevea brasiliensis, Hordeum vulgare, Humulus lupulus, lpomoea batatas, Juglans regia, Lens culinaris, Linum usitatissimum, Lycopersicon lycopersicum, Malus spec., Manihot esculenta, Medicago sativa, Musa spec., Nicotiana tabacum (N.rustica), Olea europaea, Oryza sativa, Phaseolus lunatus, Phaseolus vulgaris, Picea abies, Pinus spec., Pisum sativum, Prunus avium, Prunus persica, Pyrus communis, Ribes sylvestre, Ricinus communis, Saccharum officinarum, Secale cereale, Solanum tuberosum, Sorghum bicolor (s. vulgare), Theobroma cacao, Trifolium pratense, Triticum aestivum, Triticum durum, Vicia faba, Vitis vinifera and Zea mays.

In addition, the herbicidal mixture can also be used in crops which are tolerant to the action of herbicides owing to classic breeding or else as a result of genetic engineering.

Application of the herbicidal mixture can be by the pre-plant bum down method or by the post-emergence method. If the herbicidal mixture is less well tolerated by certain crop plants, application techniques may be used in which the herbicidal mixture is sprayed, with the aid of the spraying equipment, in such a way that as far as possible it does not come into contact with the leaves of the sensitive crop plants, while the herbicidal mixture reaches the leaves of unwanted plants growing underneath, or the bare soil surface (post-directed, lay-by).

Examples of herbicidal mixtures according to the invention for the area of one hectare:

1. To prepare 100 I of a spray liquor, the following components were used:

a) 18 g of 4-[2-methyl-3-(4,5-dihydroisoxazol-3-yl)-4-methylsulfonylbenzoyl]-1-methyl-5-hydroxy-1H-pyrazole¹)

b) 1.251 of MSO

c) 2.5 1 of UAN (urea ammonium nitrate, 48% strength solution)

d) 500 g of atrazine2)

The individual components were added to the dosage device, made up with water to 100 1 and stirred. It may be advantageous to initially charge some of the water required.

2. To prepare 100 l of a spray liquor, the following components were used:

a) 18 g of 4-[2-methyl-3-(4,5-dihydroisoxazol-3-yl)4-methylsulfonylbenzoyl]-1-methyl-5-hydroxy-1H-pyrazole¹)

b) 1.251 of MSO

c) 2.5 1 of UAN (48% strength solution)

d) 35 g of nicosulfuron3)

The individual components were added to the dosage device, made up with water to 100 l and stirred. It may be advantageous to initially charge some of the water required.

3. To prepare 100 l of a spray liquor, the following components were used:

a) 18 g of 4-[2-methyl-3-(4,5-dihydroisoxazol-3-yl)-4-methylsulfonylbenzoyl]-1-methyl-5-hydroxy-1H-pyrazole¹)

b) 1.251 of MSO

c) 2.5 1 of UAN (48% strength solution)

d) 650 g of dimethenamid⁴)

The individual components were added to the dosage device, made up with water to 100 l and stirred. It may be advantageous to initially charge some of the water required.

1) 2) 3) 4)

¹⁾, ²⁾, ³⁾ and ⁴⁾ were used in the form of the respective commercial products as formulated active compounds:

¹): Clio: 336 g/l of topramezone (4-[2-methyl-3-(4,5-dihydroisoxazol-3-yl)4-methylsulfonylbenzoyl]-1-methyl-5-hydroxy-1H-pyrazole); SC (suspension concentrate)

²) AAtrex 4L: 84 g/l of atrazine SC (suspension concentrate)

³): Accent: 75% of nicosulfuron OF

⁴) Outlook: 720 g/l of dimethanamid-P (=S-dimethenamid); EC (emulsifiable concentrate)

Use Examples:

The herbicidal action of the mixture according to the invention or the herbicidal compositions was demonstrated by greenhouse trials (Tables 1-4) using component a) 4-[2-methyl-3-(4,5-dihydroisoxazol-3-yl)-4-methylsulfonylbenzoyl]-1-methyl-5-hydroxy-1H-pyrazole by the post-emergence method;

The culture vessels used were plastic flowerpots filled, as substrate, with sandy loam comprising about 3% of humus. The seeds of the test plants were sown separated according to species.

For the post-emergence treatment, the test plants were initially cultivated to a height of 3-17 cm according to their habit and only then treated with the active compounds, which had been suspended or emulsified in water. To this end, the test plants were either sown directly and cultivated in the same vessels, or they were initially cultivated separately as seedlings and transplanted into the test vessels a few days prior to the treatment. According to the species, the plants were kept at temperatures of from 15° C. to 25° C. or from 20 to 35° C. The trial period extended over 3 weeks. During this time the plants were tended and their response to the individual treatments was evaluated.

Evaluation was carried out using a scale of 0-100. “100” means total destruction of at least the above-ground parts of the plants, and “0” means no damage or normal course of growth compared to an untreated control.

The application in the greenhouse was carried out at a spray liquor application rate of 200 l/ha.

The herbicidal action of the mixture according to the invention or the herbicidal composition was also demonstrated by outdoor experiments (Table 5) using component a) 4-[2-methyl-3-(4,5-dihydroisoxazol-3-yl)-4-methylsulfonylbenzoyl]-1-methyl-5-hydroxy-1H-pyrazole by the post-emergence method (1- to 8-leaf stage of the crop plants). The volume of the spray liquor was 140 l/ha to 200 l/ha.

COC means crop oil concentrate; AWM means application rate; d means day of the assessment. The following plant species were used in the experiments:

| Plant species | Scientific name |
|---|---|
| ABUTH | Abuthilon theophrasti |
| AMARE | Amaranthus retroflexus |
| AMASS | Amaranthus species |
| AMATA | Amaranthus tuberculatus |
| AMBEL | Ambrosia elatior |
| BIDPI | Bidens pilosa |
| BRAPL | Brachiria plantaginea |
| BRAPP | Brachiaria platyphylla |
| CHEAL | Chenopodium album |
| DIGSA | Digitaria sanguinalis |
| ECHCG | Echinochloa crus-galli |
| ELEIN | Eleusine indica |
| ERBVI | Eriochloa villosa |
| HELAN | Helianthus annua |
| PANDI | Panicum dichotomiflorum |
| PANMI | Panicum milliaceum |
| POLCO | Polygonum convolvulus |
| POLPY | Polygonum pensylvanicum |
| SETFA | Setaria fabbri |
| SETLU | Setaria lutescens |
| SETSPP | Setaria species |
| SETVI | Setaria viridis |
| SIDSP | Sida spinosa |
| SOLNI | Solanum nigrum |
| SORBI | Sorghum bicolor |
| XANST | Xanthium strumarium |
| XANSS | Xanthium species |

TABLE 1

| | AWM a.i. | MSO | Active | a) + MSO | a) + MSO |
|---|---|---|---|---|---|
| | active | 1.25% | compound a) | 1.25% | 1.25% |
| | compound | observed | observed | expected | observed |
| Plant | a) g/ha | effect | effect | effect (*) | effect |
| ECHCG | 12.5 | 0 | 0 | 0 | 90 |
| ECHCG | 25 | 0 | 0 | 0 | 90 |
| PANDI | 25 | 0 | 0 | 0 | 90 |
| PANMI | 12.5 | 0 | 75 | 75 | 90 |
| SORBI | 25 | 0 | 10 | 10 | 75 |
| SETVI | 12.5 | 0 | 60 | 60 | 90 |
| AMBEL | 3.125 | 0 | 60 | 60 | 80 |
| HELAN | 6.25 | 0 | 30 | 30 | 95 |
| SOLNI | 3.125 | 0 | 30 | 30 | 100 |
| XANST | 12.5 | 0 | 65 | 65 | 98 |

(* Colby: E = x + y − ((x * y)/100))

The herbicidal mixture according to the invention was highly effective against unwanted plants which had not been expected judging from the effectiveness of the individual compounds.

In addition, the mixture according to the invention was distinguished by a considerably higher herbicidal activity than that of mixtures comprising customary adjuvants, such as COC:

TABLE 2

| | AWM a.i. | a) + MSO | a) + COC |
|---|---|---|---|
| | active compound | 1.25% observed | 1.25% observed |
| Plant | a) g/ha | effect | effect |
| ECHCG | 12.5 | 90 | 55 |
| ECHCG | 25 | 90 | 60 |
| PANDI | 25 | 90 | 15 |
| PANMI | 12.5 | 90 | 85 |
| SORBI | 25 | 75 | 45 |
| SETVI | 12.5 | 90 | 65 |
| AMBEL | 3.125 | 80 | 75 |
| HELAN | 6.25 | 95 | 40 |
| SOLNI | 3.125 | 100 | 98 |
| XANST | 12.5 | 98 | 70 |

Even mixtures according to the invention which, in addition to components a) and b), comprise further components, for example a component d), show considerably higher herbicidal activity than mixtures comprising customary adjuvants, such as COC. In the example below (Table 3), the spray liquor comprised component b) MSO or, for comparison, COC, in a concentration of in each case 1.25% by volume:

TABLE 3

| | AWM a.i. | a) + d) atrazine (250 g/ha a.i.) | | |
|---|---|---|---|---|
| | active compound | | +COC | +MSO |
| Plant | a) g/ha | “solo” | 1.25% | 1.25% |
| BRAPL | 25 | 65 | 75 | 80 |
| DIGSA | 3.125 | 0 | 70 | 80 |
| ELEIN | 12.5 | 35 | 95 | 98 |
| SETLU | 3.125 | 0 | 40 | 50 |
| ERBVI | 25 | 75 | 85 | 95 |
| ABUTH | 6.25 | 70 | 80 | 85 |
| POLCO | 25 | 65 | 95 | 98 |

Furthermore, mixtures according to the invention which, in addition to components a) and b), comprise, for example, a component c) have considerably higher herbicidal activity than mixtures comprising customary adjuvants, such as COC. In the example below (Table 4), the spray liquor comprised component b) MSO or, for comparison, COC, in a concentration of in each case 1.25% by volume:

TABLE 4

| | AWM a.i. | a) + c) UAN 2.5% (w/w) | | |
|---|---|---|---|---|
| | active compound | | +COC | +MSO |
| Plant | a) g/ha | “solo” | 1.25% | 1.25% |
| SETLU | 3.125 | 0 | 25 | 35 |
| SETLU | 6.25 | 30 | 70 | 75 |
| DIGSA | 3.125 | 0 | 65 | 75 |
| SETFA | 12.5 | 70 | 75 | 80 |
| SETFA | 25 | 80 | 80 | 85 |
| CHEAL | 12.5 | 0 | 75 | 85 |
| BIDPI | 3.125 | 10 | 20 | 30 |
| SIDSP | 3.125 | 0 | 10 | 30 |

Mixtures according to the invention which, in addition to components a) and b), comprise further components, i.e. c) and d), also show considerably higher herbicidal acitvity than mixtures comprising customary adjuvants, such as COC. In the examples below (Table 5), the spray liquor comprised component c), UAN, in a concentration of 2.5% (w/w) and component b) MSO or, for comparison, COC, in a concentration of in each case 1.25% by volume:

TABLE 5
5a):

| Treatment | AWM a.i. active | | 19-34 d | 42-63 d | 42-63 d | 24 d |
|---|---|---|---|---|---|---|
| (a.i.) | compound g/ha | b) + c) | BRAPP | SETSPP | DIGSA | ECHCG |
| a) | 12.5 | COC + UAN | 35 | 63 | 65 | 66 |
| a) + d) atrazine | 12.5 + 252 | COC + UAN | 65 | 63 | 88 | 70 |
| a) + d) atrazine | 12.5 + 510 | COC + UAN | 58 | 74 | 95 | 82 |
| a) | 12.5 | MSO + UAN | 71 | 75 | 81 | 75 |
| a) + d) atrazine | 12.5 + 252 | MSO + UAN | 85 | 87 | 90 | 80 |
| a) + d) atrazine | 12.5 + 510 | MSO + UAN | 92 | 77 | 95 | 87 |
| a) | 18.1 | COC + UAN | 42 | 59 | 75 | 77 |
| a) + d) atrazine | 18.1 + 252 | COC + UAN | 79 | 82 | 84 | 77 |
| a) + d) atrazine | 18.1 + 510 | COC + UAN | 64 | 74 | 94 | 67 |
| a) | 18.1 | MSO + UAN | 81 | 82 | 94 | 71 |
| a) + d) atrazine | 18.1 + 252 | MSO + UAN | 87 | 90 | 94 | 77 |
| a) + d) atrazine | 18.1 + 510 | MSO + UAN | 87 | 87 | 96 | 77 |

5b):

| Treatment | AWM a.i. active | | 7-15 d | 42-63 d | 7-15 d | 42-63 d |
|---|---|---|---|---|---|---|
| (a.i.) | compound g/ha | b) + c) | ABUTH | ABUTH | AMASS | AMASS |
| a) | 12.5 | COC + UAN | 74 | 81 | 83 | 70 |
| a) + d) atrazine | 12.5 + 252 | COC + UAN | 95 | 90 | 87 | 76 |
| a) + d) atrazine | 12.5 + 510 | COC + UAN | 97 | 95 | 92 | 70 |
| a) | 12.5 | MSO + UAN | 84 | 86 | 77 | 71 |
| a) + d) atrazine | 12.5 + 252 | MSO + UAN | 96 | 93 | 89 | 78 |
| a) + d) atrazine | 12.5 + 510 | MSO + UAN | 97 | 93 | 87 | 77 |
| a) | 18.1 | COC + UAN | 78 | 84 | 84 | 71 |
| a) + d) atrazine | 18.1 + 252 | COC + UAN | 95 | 93 | 92 | 77 |
| a) + d) atrazine | 18.1 + 510 | COC + UAN | 96 | 91 | 88 | 81 |
| a) | 18.1 | MSO + UAN | 81 | 88 | 87 | 71 |
| a) + d) atrazine | 18.1 + 252 | MSO + UAN | 97 | 95 | 92 | 82 |
| a) + d) atrazine | 18.1 + 510 | MSO + UAN | 96 | 95 | 94 | 84 |

5c):

| Treatment | AWM a.i. active | | 7-15 d | 7-15 d | 42-63 d |
|---|---|---|---|---|---|
| (a.i.) | compound g/ha | b) + c) | XANSS | AMARE | AMARE |
| a) | 12.5 | COC + UAN | 27 | 77 | 78 |
| a) + d) atrazine | 12.5 + 252 | COC + UAN | 65 | 98 | 95 |
| a) + d) atrazine | 12.5 + 510 | COC + UAN | 78 | 100 | 100 |
| a) | 12.5 | MSO + UAN | 37 | 80 | 91 |
| a) + d) atrazine | 12.5 + 252 | MSO + UAN | 82 | 100 | 98 |
| a) + d) atrazine | 12.5 + 510 | MSO + UAN | 82 | 100 | 99 |
| a) | 18.1 | COC + UAN | 33 | 73 | 90 |
| a) + d) atrazine | 18.1 + 252 | COC + UAN | 63 | 100 | 92 |
| a) + d) atrazine | 18.1 + 510 | COC + UAN | 72 | 100 | 96 |
| a) | 18.1 | MSO + UAN | 45 | 83 | 98 |
| a) + d) atrazine | 18.1 + 252 | MSO + UAN | 67 | 100 | 96 |
| a) + d) atrazine | 18.1 + 510 | MSO + UAN | 82 | 100 | 96 |

5d):

| Treatment | AWM a.i. active | | 51-78 d | 51-78 d | 51-78 d | 51-78 d |
|---|---|---|---|---|---|---|
| (a.i.) | compound g/ha | b) + c) | DIGSA | ELEIN | SETFA | ECHCG |
| a) + d) atrazine | 12.5 + 510 | COC + UAN | — | — | 63 | — |
| a) + d) atrazine | 12.5 + 510 | MSO + UAN | — | — | 80 | — |
| a) + d) atrazine | 18.1 + 510 | COC + UAN | 97 | 99 | 71 | 99 |
| a) + d) atrazine | 18.1 + 510 | MSO + UAN | 100 | 100 | 86 | 100 |

5e):

| Treatment | AWM a.i. active | | 51-78 d | 51-78 d | 51-78 d |
|---|---|---|---|---|---|
| (a.i.) | compound g/ha | b) + c) | SETLU | SETVI | SORBI |
| a) + d) atrazine | 12.5 + 510 | COC + UAN | — | 67 | — |
| a) + d) atrazine | 12.5 + 510 | MSO + UAN | — | 82 | — |
| a) + d) atrazine | 18.1 + 510 | COC + UAN | 100 | 64 | 23 |
| a) + d) atrazine | 18.1 + 510 | MSO + UAN | 100 | 84 | 43 |

5f):

| Treatment | AWM a.i. active | | 51-78 d | 51-78 d | 51-78 d | 51-78 d |
|---|---|---|---|---|---|---|
| (a.i.) | compound g/ha | b) + c) | ABUTH | AMARE | AMASS | AMATA |
| a) + d) atrazine | 18.1 + 510 | COC + UAN | 91 | 86 | 82 | 93 |
| a) + d) atrazine | 18.1 + 510 | MSO + UAN | 94 | 87 | 86 | 93 |
| a) + d) Accent | 18.1 + 36.3 | COC + UAN | 90 | 85 | 75 | 91 |
| a) + d) Accent | 18.1 + 36.3 | MSO + UAN | 86 | 90 | 89 | 94 |
| a) + d) Accent + | 18.1 + 36.3 + | COC + UAN | 92 | 95 | 88 | 95 |
| d) atrazine | 510 | | | | | |
| a) + d) Accent + | 18.1 + 36.3 + | MSO + UAN | 95 | 95 | 95 | 97 |
| d) atrazine | 510 | | | | | |

5g):

| Treatment | AWM a.i. active | | 51-78 d | 51-78 d | 51-78 d |
|---|---|---|---|---|---|
| (a.i.) | compound g/ha | b) + c) | CHEAL | HELAN | POLPY |
| a) + d) atrazine | 18.1 + 510 | COC + UAN | 93 | 96 | 92 |
| a) + d) atrazine | 18.1 + 510 | MSO + UAN | 99 | 96 | 92 |
| a) + d) Accent | 18.1 + 36.3 | COC + UAN | 80 | 84 | 73 |
| a) + d) Accent | 18.1 + 36.3 | MSO + UAN | 95 | 87 | 77 |
| a) + d) Accent + | 18.1 + 36.3 + | COC + UAN | 99 | 96 | 93 |
| d) atrazine | 510 | | | | |
| a) + d) Accent + | 18.1 + 36.3 + | MSO + UAN | 100 | 95 | 95 |
| d) atrazine | 510 | | | | |

1. A mixture, comprising
a) a 4,5-dihydroisoxazol-3-yl-substituted benzoyl derivative of the formula I, 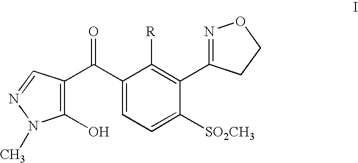
or an environmentally compatible salts, esters or amides thereof, wherein R is chlorine or methyl; and
b) esters of C₆-C₂₂-fatty acids of vegetable origin.

2. The mixture according to claim 1, wherein component a) is the compound 4-[2-methyl-3-(4,5-dihydroisoxazol-3-yl)-4-methylsulfonylbenzoyl]-1-methyl-5-hydroxy-1H-pyrazole.

3. The mixture according to claim 1 which comprises the components a) and b) in a synergistic herbicidally effective amount.

4. The mixture according to claim 1 which comprises the components a) and b) in a ratio (w/w) of from 1:2.5 to 1:5000.

5. The mixture according to claim 1 which comprises, as a further components, c) nitrogenous fertilizers and/or d) other herbicides and/or e) safeners.

6. The mixture according to claim 5 which comprises the components a) and c) nitrogenous fertilizers in a ratio (w/w) of from 1:2.5 to 1:10 000.

7. The mixture according to claim 5 which comprises the components a) and d) other herbicides in a ratio (w/w) of from 1:0.001 to 1:500.

8. A process for preparing a mixture according to claim 1 wherein component a) is mixed with component b).

9. A herbicidally active composition comprising a mixture according to claim 1, at least one inert liquid and/or solid carrier and optionally at least one surfactant.

10. The herbicidally active composition according to claim 9, wherein the component b) has a concentration of from 0.5% by volume to 2.5% by volume.

11. The herbicidally active composition according to claim 9, wherein the composition also comprises a component c) nitrogenous fertilizers in a concentration of from 0.5% by weight to 5% by weight.

12. A process for preparing a composition according to claim 9, wherein the components a) and b) of the mixture, at least one inert liquid and/or solid carrier and optionally at least one surfactant are mixed with one another.

13. (canceled)

14. (canceled)

15. A method for controlling unwanted vegetation wherein a mixture according to claim 1 is allowed to act on unwanted plants and/or their habitat.

16. A method for controlling unwanted vegetation wherein the components of the mixture according to claim 1 are allowed to act jointly or separately, simultaneously or sequentially on unwanted plants, their seed and/or their habitat.

17. A method for controlling unwanted vegetation comprising jointly or separately, simultaneously or sequentially, applying to the unwanted vegetation or seed or habitat thereof a synergistically effective amount of a) a 4,5-dihydroisoxazol-3-yl-substituted benzoyl derivative of the formula I, 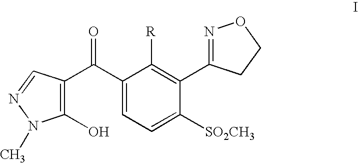
or environmentally compatible salt, ester or amide thereof, wherein R is chlorine or methyl; and
b) esters of C₆-C₂₂-fatty acids of vegetable origin.

18. The method of claim 17, wherein the benzoyl derivative is 4-[2-methyl-3-(4,5-dihydroisoxazol-3-yl)-4-methylsulfonylbenzoyl]-1-methyl-5-hydroxy-1H-pyrazole

19. The method of claim 17, wherein the weight ratio of components a) and b) is from 1:25 to 1:5000.

20. The method of claim 17, wherein the compoinents a) and b) are applied in the form of a mixture in at least one liquid carrier and/or solid carrier.

21. A kit for preparing a herbicidal mixture comprising, in separate containers, a) a 4,5-dihydroisoxazol-3-yl-substituted benzoyl derivative of the formula I, 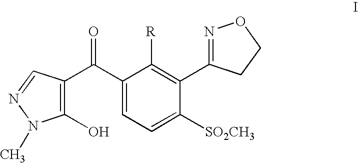
where R is chlorine or methyl, or one of its environmentally compatible salts, esters or amides; and
b) esters of C₆-C₂₂-fatty acids of vegetable origin.
